(19) United States
(12) Patent Application Publication
(10) Pub. No.: US 2012/0205832 A1
(43) Pub. Date: Aug. 16, 2012

(54) Polyolefin manufacturing process

(76) Inventors: Waseem Rahim, League City, TX (US); Robert Sander, La Porte, TX (US)

(21) Appl. No.: 12/931,964

(22) Filed: Feb. 15, 2011

(51) Int. Cl. B29B 9/10

(52) U.S. Cl. 264/142

(57) ABSTRACT

The present invention relates to an improved process for compounding a polyolefin composition comprising providing feed components including one or more high molecular weight olefin polymer components and one or more low molecular weight polyolefin components. The high and low molecular weight components are then compounded together to create a molten homogeneous polyolefin mixture.

### BACKGROUND OF THE INVENTION

1. Field of Invention

The invention relates to an improved process for manufacturing polyolefin blends made from a high molecular weight olefin copolymer and a low molecular weight olefin copolymer. In particular, the invention relates to optimizing the balance between dispersive and distributive mixing, while maintaining product properties, improving energy input into the product, ensuring mixing consistency and achieving improved production rates.

2. Description of the Prior Art

Polyolefin manufacturing processes are well known in the art, including processes for producing monomodal and multimodal polymers depending on the requirements of the finished polyolefin product.

In particular, multimodal polyethylene is well known in the art, as described in U.S. Pat. No. 6,730,751 and U.S. Pat. No. 7,193,017, the disclosures of which are hereby incorporated by reference. The term “multimodal” as used herein refers to the presence of more than one defined peak in a graph of molecular weight distribution. When polymer is produced in sequential steps in two or more separate reaction vessels, polymers of different molecular weight distributions and density can be produced.

While the separate components might have monomodal molecular weight distributions, the effect of this sequential continuous multistep process is to superimpose one distribution on top of the other—resulting in a bimodal or multimodal distribution of molecular weights. Alternatively, this type of polymer can be produced by a physical mixing of the different components prepared separately and then combined. For some applications such as pressure pipes it has been recognized that it is advantageous to use blends made from a low molecular weight ethylene polymer and high molecular weight ethylene polymer.

Multimodal polyolefins require special treatment in the finishing step of manufacturing in order to achieve desired final properties such as reducing gels for improved appearance as well as improving the dispersion of additives and pigments that may be used. The polymer may be compounded on various pieces of extrusion equipment including a mixer plus extruder configuration, such as in a Farrel mixer plus single screw extruder, a Farrel type mixer plus gear pump, a twin screw extruder alone, or a twin screw extruder plus gear pump as described in U.S. Pat. No. 6,900,266, the disclosure of which is hereby incorporated by reference.

Under one commonly used prior art method, pellets are produced on a Farrel type mixer plus single screw extruder including a feed tower to introduce the polymer flake and combine it with additives appropriate for the application which include antioxidants, acid scavengers, and polymer processing aids. The Farrel type mixer receives the combined flows of these materials and melts them and mixes them in the mixing chamber formed by the rotors, the mixing chamber, and the orifice restrictive device. The single screw extruder receives the melt from the mixer and pressurizes it through a pelletizing die plate where the polymer flow is divided into separate streams and cut into pellets in an underwater pelletizer. Farrel Corporation has published “Effect of rotor geometry and operating conditions on mixing performance in continuous mixers: an experimental study” in 1991 at SPE Antec, the disclosure of which is hereby incorporated by reference, which describes various rotor configurations for polymer melt processing on Farrel Continuous Mixers.

Prior art references disclose various lobe designs and extruder configurations for the various compounding configurations. For example, U.S. Pat. No. 6,783,270 discloses a twin-screw extruder having a novel fractional element that can provide different tip angles. However, none of the prior art references describe an optimum rotor configuration for mixing and melting multimodal polyolefins.

It is also well known in the art that it is important to control energy input to the polyolefin polymer during the compounding process as shown in U.S. Pat. No. 6,900,266, the disclosure of which is hereby incorporated by reference. An energy level that is too high may degrade desirable mechanical properties while an energy level that is too low may be inadequate to produce material that has the needed homogeneity for a given application, such as pipes.

White spots and gels are two performance indicators that are used to evaluate homogeneity of multimodal polyolefins. Undesirable levels of either gels or white spots result in unusable polymer products. U.S. Patent Application No. 2009/0198018, the disclosure of which is hereby incorporated by reference, describes processes for producing multimodal polymer with reduced white spots.

### SUMMARY OF THE INVENTION

The present invention relates to an improved process for compounding a polyolefin composition comprising providing feed components including one or more high molecular weight olefin polymer components and one or more low molecular weight polyolefin components. The high and low molecular weight components are then compounded together to create a molten homogeneous polyolefin mixture. The term “homogeneous polymer” is used herein to mean that the pellets made by the extruder and relatively the same, one to the other, and have the same properties of viscosity and density

### DETAILED DESCRIPTION OF THE DRAWINGS

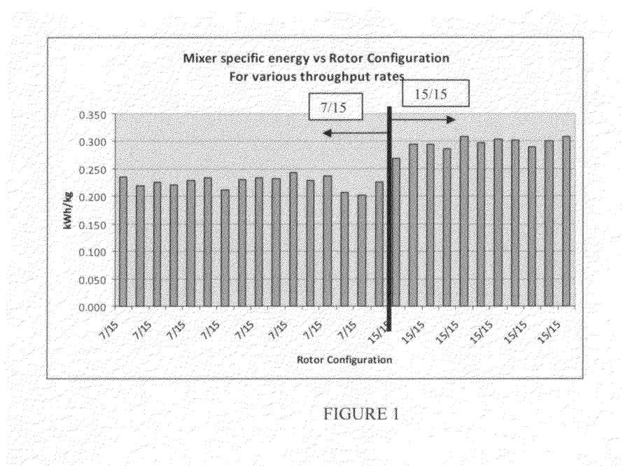

FIG. 1 is a graph showing the specific energy use of heterogeneous rotor configurations according to the invention.

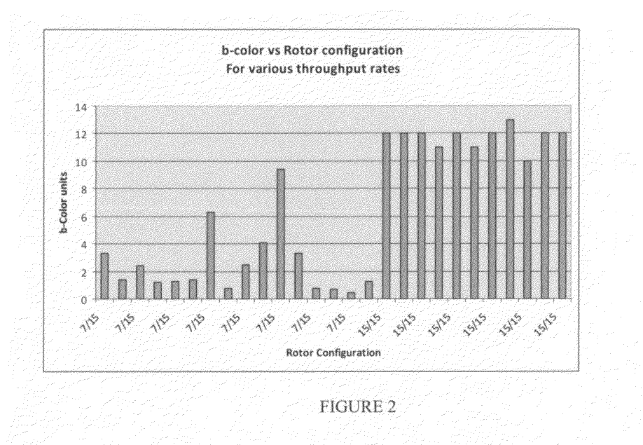

FIG. 2 is a graph showing b-color results for polymer pellets manufactured with heterogeneous rotor configurations at varying rotor speeds.

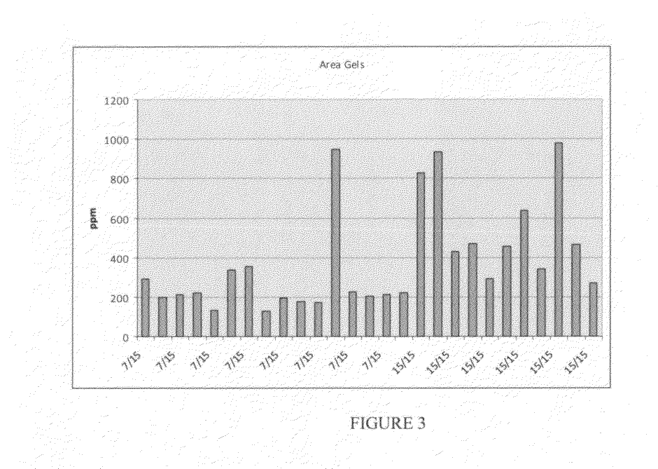

FIG. 3 is a graph showing area gel results for polymer pellets manufactured with heterogeneous rotor configurations at varying rotor speeds.

### DETAILED DESCRIPTION OF PROCESS

Preferably, the present invention relates to a process used for compounding of a multimodal polyolefin composition at a high production rate from the compounding line while achieving high levels of homogeneity (as evidenced by reduced gels and reduced white spots), and minimum polymer degradation (evidenced by low color levels) thereby maintaining the physical properties of the polymer melt.

Most polyolefin producers pelletize the reactor-made polymer before packaging the polymer and sending it to the customer. The reactor-made polymer must be melted and extruded to homogenize the polymer, to melt it and mix it with various additives which are usually present in ppm levels, and to produce nominal ⅛″ diameter pellets that are easier to handle.

According to a preferred process of the invention, one or more high molecular weight olefin polymer components and one or more low molecular weight polyolefin components are provided as the feedstock to a continuous feeding system that delivers the components into one or more reaction vessels.

The polymerization temperatures for the process of the invention may be in the range of from −60° C. to about 280° C., preferably from 50° C. to about 200° C., and the pressures employed may be in the range from 1 atmosphere to about 500 atmospheres or higher.

Polymerization processes include solution, gas phase, slurry phase and a high pressure process or a combination thereof. Particularly preferred is a gas phase or slurry phase polymerization of one or more olefins at least one of which is ethylene or propylene.

In one embodiment, the process of this invention is directed toward a solution, high pressure, slurry or gas phase polymerization process of one or more olefin monomers having from 2 to 30 carbon atoms, preferably 2 to 12 carbon atoms, and more preferably 2 to 8 carbon atoms. The invention is particularly well suited to the polymerization of two or more olefin monomers of ethylene, propylene, butene-1, pentene-1,4-methyl-pentene-1, hexene-1, octene-1 and decene-1.

Other monomers useful in the process of the invention include ethylenically unsaturated monomers, diolefins having 4 to 18 carbon atoms, conjugated or nonconjugated dienes, polyenes, vinyl monomers and cyclic olefins. Non-limiting monomers useful in the invention may include norbornene, norbornadiene, isobutylene, isoprene, vinylbenzocyclobutane, styrenes, alkyl substituted styrene, ethylidene norbornene, dicyclopentadiene and cyclopentene.

In the most preferred embodiment of the process of the invention, a copolymer of ethylene is produced, where with ethylene, a comonomer having at least one alpha-olefin having from 3 to 15 carbon atoms, preferably from 4 to 12 carbon atoms, and most preferably from 4 to 8 carbon atoms, is polymerized in a slurry phase process.

In another embodiment of the process of the invention, ethylene or propylene is polymerized with at least two different comonomers, optionally one of which may be a diene, to form a terpolymer.

In an embodiment, the mole ratio of comonomer to ethylene, C x/C₂, where C x is the amount of comonomer and C 2 is the amount of ethylene is between about 0.001 to 0.200 and more preferably between about 0.002 to 0.008.

In one embodiment, the invention is directed to a polymerization process, particularly a gas phase or slurry phase process, for polymerizing propylene alone or with one or more other monomers including ethylene, and/or other olefins having from 4 to 12 carbon atoms. Polypropylene polymers may be produced using the particularly bridged bulky ligand metallocene catalysts as described in U.S. Pat. Nos. 5,296,434 and 5,278,264, the disclosures of which are herein incorporated by reference.

Typically in a gas phase polymerization process a continuous cycle is employed where in one part of the cycle of a reactor system, a cycling gas stream, otherwise known as a recycle stream or fluidizing medium, is heated in the reactor by the heat of polymerization. This heat is removed from the recycle composition in another part of the cycle by a cooling system external to the reactor. Generally, in a gas fluidized bed process for producing polymers, a gaseous stream containing one or more monomers is continuously cycled through a fluidized bed in the presence of a catalyst under reactive conditions. The gaseous stream is withdrawn from the fluidized bed and recycled back into the reactor. Simultaneously, polymer product is withdrawn from the reactor and fresh monomer is added to replace the polymerized monomer. (See for example U.S. Pat. Nos. 4,543,399, 4,588,790, 5,028,670, 5,317,036, 5,352,749, 5,405,922, 5,436,304, 5,453,471, 5,462,999, 5,616,661 and 5,668,228, all of which are fully incorporated herein by reference.)

The reactor pressure in a gas phase process may vary from about 100 psig (690 kPa) to about 600 psig (4138 kPa), preferably in the range of from about 200 psig (1379 kPa) to about 400 psig (2759 kPa), more preferably in the range of from about 250 psig (1724 kPa) to about 350 psig (2414 kPa).

The reactor temperature in a gas phase process may vary from about 30° C. to about 120° C., preferably from about 60° C. to about 115° C., more preferably in the range of from about 70° C. to 110° C., and most preferably in the range of from about 70° C. to about 95° C.

Other gas phase processes contemplated by the process of the invention include series or multistage polymerization processes. Also gas phase processes contemplated by the invention include those described in U.S. Pat. Nos. 5,627,242, 5,665,818 and 5,677,375, and European publications EP-A-0 794 200 EP-B1-0 649 992, EP-A-0 802 202 and EP-B-634 421 all of which are herein fully incorporated by reference.

In a preferred embodiment, the reactor utilized in the present invention is capable of and the process of the invention is producing greater than 500 lbs of polymer per hour (227 Kg/hr) to about 200,000 lbs/hr (90,900 Kg/hr) or higher of polymer, preferably greater than 1000 lbs/hr (455 Kg/hr), more preferably greater than 10,000 lbs/hr (4540 Kg/hr), even more preferably greater than 25,000 lbs/hr (11,300 Kg/hr), still more preferably greater than 35,000 lbs/hr (15,900 Kg/hr), still even more preferably greater than 50,000 lbs/hr (22,700 Kg/hr) and most preferably greater than 65,000 lbs/hr (29,000 Kg/hr) to greater than 100,000 lbs/hr (45,500 Kg/hr).

A slurry polymerization process generally uses pressures in the range of from about 1 to about 50 atmospheres and even greater and temperatures in the range of 0° C. to about 120° C. In a slurry polymerization, a suspension of solid, particulate polymer is formed in a liquid polymerization diluent medium to which ethylene and comonomers and often hydrogen along with catalyst are added. The suspension including diluent is intermittently or continuously removed from the reactor where the volatile components are separated from the polymer and recycled, optionally after a distillation, to the reactor. The liquid diluent employed in the polymerization medium is typically an alkane having from 3 to 7 carbon atoms, preferably a branched alkane. The medium employed should be liquid under the conditions of polymerization and relatively inert. When a propane medium is used the process must be operated above the reaction diluent critical temperature and pressure. Preferably, a hexane or an isobutane medium is employed.

A preferred polymerization technique of the invention is referred to as a particle form polymerization, or a slurry process where the temperature is kept below the temperature at which the polymer goes into solution. Such technique is well known in the art, and described in for instance U.S. Pat. No. 3,248,179 which is fully incorporated herein by reference. Other slurry processes include those employing a loop reactor and those utilizing a plurality of stirred reactors in series, parallel, or combinations thereof. Non-limiting examples of slurry processes include continuous loop or stirred tank processes. Also, other examples of slurry processes are described in U.S. Pat. Nos. 4,613,484 and 5,986,021, which are herein fully incorporated by reference.

In an embodiment the reactor used in the slurry process of the invention is capable of and the process of the invention is producing greater than 2000 lbs of polymer per hour (907 Kg/hr), more preferably greater than 5000 lbs/hr (2268 Kg/hr), and most preferably greater than 10,000 lbs/hr (4540 Kg/hr). In another embodiment the slurry reactor used in the process of the invention is producing greater than 15,000 lbs of polymer per hour (6804 Kg/hr), preferably greater than 25,000 lbs/hr (11,340 Kg/hr) and most preferably greater than about 100,000 lbs/hr (45,500 Kg/hr).

Examples of solution processes are described in U.S. Pat. Nos. 4,271,060, 5,001,205, 5,236,998, 5,589,555 and 5,977,251 and PCT WO 99/32525 and PCT WO 99/40130, which are fully incorporated herein by reference

Various methods are used to accomplish this process but all incorporate a continuous feeding system capable of maintaining a constant ratio between the powdered polyolefin components and any additional additives that are incorporated as part of the recipe stream of the first step. Once all of the ingredients are mixed together to achieve the desired ratio, it produces a homogenous recipe stream.

The recipe stream is introduced to the inlet of a mixing and melting device at a constant rate. The high and low molecular weight components are then compounded together to create a molten homogeneous bimodal polyolefin mixture, or “melt”.

This mixing step may be carried out, for example, in a continuous mixer like a Farrel Continuous Mixer (FCM), or in a twin screw extruder like a Coperion ZSK. In a preferred embodiment, an FCM is used for the step of mixing and for the subsequent melting step. The mixer rotors infeed the powder to an enclosed chamber to compress the powder between the rotors themselves and between the rotors and the chamber walls.

This is done in such a way that the friction between the powder particles and the rotors and walls is sufficient to melt the polymer and create a pool of molten polymer and additives. In this way the polymer and additives are mixed and homogenized.

Specific energy is a measure of motor energy input into the melt in the mixer and is defined as the kilowatt (“kW”) of motor power divided by the polymer throughput in kilograms per hour (“kg/h”). By varying the specific energy it is possible to influence the residence time of the melt pool in the mixer.

According to the process of the invention, it was found that varying the specific energy in the mixer changed the melt behavior in the extruder. The extruder behavior was optimized in tandem with the mixer which allowed increased throughput rate overall. Working with the mixer and extruder in tandem it is possible to maximize forward flow in the extruder due to increased friction of the melt with the extruder walls thereby increasing production rate. In a preferred embodiment, the specific energy was maintained at less than 0.2 kWh/kg.

The residence time of the melt in the mixer is influenced by the rotor type and certain process control devices such as discharge orifices, radial gate valves or rotary bars.

Decreasing the size of the orifice opening has the effect of raising the polymer melt temperature as well as increasing the amount of time the polymer spends in the mixer. The rotor type also affects the mixing time and the path taken by the polymer as it moves from the inlet to the discharge of the mixing chamber. For instance, the style 15/15 rotor combination used in the FCM is intended to give a relatively large residence time in the mixer at any orifice opening size as compared to the style 7/15 rotor combination.

In addition to the rotor styles described above, other useful models include the style 22 and style 24 two stage rotors, as compared to the style 7 and 15 single stage rotors. Stages refer to separate areas of mixing in a rotor. Styles 7 and 15 have only an infeed flight area and then an area of apexes of interaction where melting and mixing occur. In styles 22 and 24, there is a second, shorter zone of secondary mixing.

According to one embodiment, two dissimilar rotor designs are used, so that the apexes of the rotors are offset from each other. The offset may be axial or tangential in orientation. This minimizes product melt bypass and increases dispersive mixing. With improved mixing there is a reduction in gels in the final product. Preferably, the gel area of a film generated from the polyolefin composition is less than 265 per 236 square inches.

According to this embodiment, the rotors are equipped with alternating lobe combinations, preferably staggered helix rotors, in the mixer assembly to achieve a lower energy and a higher rate than is possible with a mixer assembly with similar rotors. The prior art teaches the use of similar rotors within the mixer assembly which yields a higher specific energy, kWh/kg. As indicated herein, a higher specific energy results in increases in melt index and some degradation of the final pellet product.

The use of dissimilar rotors allows for more efficient dispersion and back-mixing of the polymer melt inside the mixer. Due to the improvements in mixing and dispersion, the final polymer melt leaving the mixer is more homogenous and has a lower gel level. In addition, with greater homogeneity and fewer hot spots the mixer assembly achieves lower specific energy, kWh/kg, than a comparable assembly with matched apex rotors.

Alternatively, an embodiment of the process utilizes rotors operated at different speeds. Current practice according to the prior art is to use rotors turning at the same speed. Utilizing differing rotor speeds allows the process practitioner to precisely control the energy input to an optimum level while maximizing the melt throughput. This results in an improved process where the final pellet product exhibits reduced gels and lower color while maintaining the physical properties of the final pellet product. Preferably, the color as measured by the b-color standard will be less than 5.0.

According to this embodiment, the orientation of one rotor with the other is either fixed when they are rotating at the same speed or the orientation is constantly changing when they are turning at different speeds. Lower speeds are common in mixers of larger diameters. Typical values according to the preferred embodiment for the two speeds are from about 228 rpm to about 258 rpm for 12″ diameter FCM's with higher rpm ranges used for smaller machines down to 4″ diameter and lower speeds used for larger machines up to 21″ diameter.

According to the variable speed embodiment, the process of the invention achieves lower usage of specific energy (kWh/kg), keeping the temperature of the melt entering the extruder low. The reduced melt temperature to the extruder allows for increased friction of the melt to the extruder wall. The increased friction is critical to increasing the forward movement of the molten polymer. By controlling the specific energy input to the polymer melt and keeping such to a minimum, the practitioner can thus achieve increased production rate from the same size extruder. Furthermore, the ability to control specific energy to a minimum allows the process to minimize polymer degradation, as evidenced by whiter looking pellets.

The actual mixing area of the process of the invention starts immediately after the infeed flights end. It consists of a zone of forward moving action and immediately followed by some reverse moving action. This conflicting motion forces polymer to be compressed and melted and mixed.

The third step of the process of the invention is pressurization of the melt through a die plate with the intent of producing pellets. Suitable equipment for use in this step includes the FCM single screw extruder (as described above), a gear pump such as those produced by Maag, or a twin screw extruder such as produced by Coperion.

The pressurization step functions to develop sufficient pressure behind the molten polymer so as to push the polymer through a pelletizing die plate. The single screw extruder used in this process is one that has a variable speed drive motor. The speed is regulated so as to match the output of the extruder with the output of the mixer in the second step.

The extruder receives a molten polymer stream as a gravity feed in a chute designed to contain the molten polymer stream and direct it at the inlet to the extruder screw. The melt is introduced to the flights of the extruder screw. A reciprocating ram is mounted on the side of the inlet hopper of the extruder screw to assist in pushing the molten polymer into the screw flights. The flow from the extruder is matched to the output of the mixer by adjusting the extruder screw rotations per minute (“rpm”).

The pressurized melt is then sent through a pelletizing die plate where the polymer flow is divided into separate streams and cut into homogeneous multimodal polyolefin composition pellets.

According to one embodiment of the invention, the homogeneous multimodal polyolefin pellet product comprises a bimodal polyethylene blends made from a higher molecular weight ethylene copolymer and a lower molecular weight ethylene polymer and having a melt index (MI5) 190/5 of from 0.15 to 0.45 g/10 min, a density of from 0.947 to 0.955 g/cc, an environmental stress cracking resistance ESCR (PENT)>500 hr. MI5 and ESCR (PENT) are ASTM tests for measuring the viscosity and stress crack resistance of polyolefins.

The polymers produced by the process of the invention can be used in a wide variety of products and end-use applications. The polymers produced by the process of the invention include linear low density polyethylene, elastomers, plastomers, high density polyethylenes, medium density polyethylenes, low density polyethylenes, multimodal or bimodal high molecular weight polyethylenes, polypropylene and polypropylene copolymers.

The polymers, typically ethylene based polymers, have a density in the range of from 0.86 g/cc to 0.97 g/cc, depending on the desired use. For some applications a density in the range of from 0.88 g/cc to 0.920 g/cc is preferred while in other applications, such as pipe, film and blow molding, a density in the range of from 0.930 g/cc to 0.965 g/cc is preferred. For low density polymers, such as for film applications, a density of 0.910 g/cc to 0.940 g/cc is preferred. Density is measured in accordance with ASTM-D-1238.

The polymers produced by the process of the invention may have a molecular weight distribution, a ratio of weight average molecular weight to number average molecular weight (M w/M n), of greater than 1.5 to about 70. In some embodiments the polymer produced has a narrow M w/M n of about 1.5 to 15, while in other embodiments the polymer produced has an M w/M n of about 30 to 50. Also, the polymers of the invention may have a narrow or broad composition distribution as measured by Composition Distribution Breadth Index (CDBI). Further details of determining the CDBI of a copolymer are known to those skilled in the art. See, for example, PCT Patent Application WO 93/03093, published Feb. 18, 1993, which is fully incorporated herein by reference. In some embodiments the polymer produced may have a CDBI of 80% or more or may have a CDBI of 50% or less.

The polymers of the invention in one embodiment have CDBI's generally in the range of greater than 50% to 100%, preferably 99%, preferably in the range of 55% to 85%, and more preferably 60% to 80%, even more preferably greater than 60%, still even more preferably greater than 65%.

In another embodiment, polymers produced using this invention have a CDBI less than 50%, more preferably less than 40%, and most preferably less than 30%.

The polymers of the present invention in one embodiment have a melt index (MI) or (I 2) as measured by ASTM-D-1238-E in the range from 0.01 dg/min to 1000 dg/min, more preferably from about 0.01 dg/min to about 100 dg/min, even more preferably from about 0.01 dg/min to about 50 dg/min, and most preferably from about 0.1 dg/min to about 10 dg/min.

The polymers of the invention in an embodiment have a melt index ratio (I 21/I 2) (I 21 is measured by ASTM-D-1238-F) of from 10 to less than 25, more preferably from about 15 to less than 25.

The polymers of the invention in a preferred embodiment have a melt index ratio (I 21/I 2) (I 21 is measured by ASTM-D-1238-F) of from preferably greater than 25, more preferably greater than 30, even more preferably greater that 40, still even more preferably greater than 50 and most preferably greater than 65. In an embodiment, the polymer of the invention may have a narrow molecular weight distribution and a broad composition distribution or vice-versa, and may be those polymers described in U.S. Pat. No. 5,798,427, the disclosure of which is incorporated herein by reference.

### EXAMPLES

The following examples are presented to illustrate various embodiments of the invention. They are not intended to be representative of all embodiments of the invention and should be not construed to limit the scope of the claimed invention as described here. All numbers described herein are approximate values and may vary within their accuracy ranges.

### Example 1

A series of tests were done using one style 7 plus one style 15 rotor (abbreviated 7/15) and various throughput rates and temperatures and these were followed by a set of experiments on the same equipment but with two style 15 rotors (abbreviated 15/15). A bimodal polyethylene polymer was used. The energy consumed by the mixer was measured as kWh/kg and the b-color and gels of the pellets were measured. The results of these trials are displayed in the graphs below.

B-color is a standard ASTM test which measures a yellowness of polymer. A lower number means less yellowness and a higher quality product. As shown in the tables below, b-color for pellets was reduced from 11.7 when using matched Farrell 15/15 rotors to 2.5 by using the dissimilar rotor orientation of the invention. In the case of a multimodal polyethylene pellet a b-color of lower than 4.0 is preferred.

Gel area is a test which measures the amount of unmelted material in a film produced from the material. As with b-color, the lower the number, the better the quality of the final product. As shown in the tables below, the gel area was reduced from 555 per 236 square inches to 265 per 236 square inches.

The tests in this example were conducted on a 4″ Farrel mixer plus 4″ Farrel under extruder evaluated at various rotor speeds and with the orifice adjusted to achieve targeted energy levels. A first set of experiments were conducted using style 7 rotor plus style 15 rotor. The second set of experiments were conducted using two style 15 rotors and the same set of trials were repeated with these rotors.

The trial matrix for each set of experiments is shown in the table below.

Trial matrix for testing

| Run # | CenterPt | Rotors | Rate | Rotor rpm |
|---|---|---|---|---|
| 1 | 1 | style 7/15 | 667 | 383 |
| 2 | 0 | style 7/15 | 556 | 418 |
| 3 | 1 | style 7/15 | 444 | 383 |
| 4 | 1 | style 7/15 | 667 | 453 |
| 5 | 0 | style 7/15 | 556 | 418 |
| 6 | 1 | style 7/15 | 444 | 453 |
| 7 | 1 | style 7/15 | 519 | 383 |
| 8 | 0 | style 7/15 | 444 | 418 |
| 9 | 1 | style 7/15 | 519 | 453 |
| 10 | 1 | style 7/15 | 370 | 383 |
| 11 | 1 | style 7/15 | 370 | 453 |
| 12 | 0 | style 7/15 | 444 | 418 |
| 1 | 1 | style 15/15 | 667 | 383 |
| 2 | 0 | style 15/15 | 556 | 418 |
| 3 | 1 | style 15/15 | 444 | 452 |
| 4 | 1 | style 15/15 | 667 | 452 |
| 5 | 1 | style 15/15 | 444 | 383 |
| 6 | 0 | style 15/15 | 556 | 418 |
| 7 | 1 | style 15/15 | 519 | 452 |
| 8 | 0 | style 15/15 | 444 | 418 |
| 9 | 1 | style 15/15 | 519 | 383 |
| 10 | 0 | style 15/15 | 444 | 418 |
| 11 | 1 | style 15/15 | 370 | 383 |
| 12 | 1 | style 15/15 | 370 | 452 |

For all tests conducted using 15/15 rotors, degradation was evident via the evolution of smoke from the mixer discharge and from two distinct zones in the mixer melt ribbon.

### Example 2

The difference between mixers running equal speed versus mixers running unequal speeds was evaluated. Commercial lines were compared running the same multimodal polyethylene with mixer 1 running 7/15 rotors at the same 300 rpm speed and a second mixer running 7/15 rotors, one running 258 rpm and the other at 228 rpm. The table below shows the difference in energy consumed for the same rate.

| | Mixer 1 | Mixer 2 |
|---|---|---|
| Rotors | 7/15 | 7/15 |
| Rate lbs/hr | 13600 | 13500 |
| Mixer energy kWh/kg | 0.205 | 0.165 |
| Rotor speed rpm | 300 and 300 | 258 and 228 |

### Example 3

Trials were run on a 12″ mixer where the specific energy was at 0.20-0.23 and then where the energy was dropped to 0.17 to 0.19 kWh/kg. In both cases, the rotors were turning at uneven speeds, one at 258 rpm and the other at 228 rpm and the polymer feed was multimodal polyethylene flake. The process of the invention resulted in a 50% higher rate at the lower mixer energy as shown in the table below. The key component of the increase is due to applying less energy to the melt in the mixer, allowing the extruder to handle a more viscous melt. The single screw extruder is more efficient in taking infeed of a viscous melt, the melt sticks less to the screw, the extruder barrel is cooled and the melt sticks to the barrel, and the drag flow is stronger with respect to the pressure flow. At the same time, the polymer stuffer ram clearance was decreased from approximately 0.75″ to less than 0.5″.

| | Case 1 | Case 2 |
|---|---|---|
| Mixer energy kWh/kg | 0.221 | 0.186 |
| Total energy kWh/kg | 0.302 | 0.267 |
| Crammer clearance, in. | 0.75 | <0.50 |
| Rate lbs/hr | 8,870 | 13,362 |

### Example 4

Evaluations were performed on a 4″ diameter semi works line and commercial production lines employing a mixer/extruder to evaluate performance of a bimodal polyethylene resin for production rates and specific energy. The results show that the specific energy needed to melt the polymer was lowered to less than 0.25 kWh/kg using different rotors vs. 0.29 when the similar rotor designs are operated at the same speed. In commercial lines, the energy using dissimilar rotors was reduced to below 0.2 kWh/kg and the production rate was increased from 10,500 lbs/hr to 13,500 lbs/hr on a 12″ mixer plus 12″ extruder.

Evaluations performed on a 1500 lbs/hr sized mixer assembly to evaluate performance of various configurations of rotors for pelletizing bimodal polyethylene showed the benefits of the process of the invention. Higher specific energy was observed on the configuration where same style rotors were used. The molten polymer observed exiting the mixer above the extruder showed two distinct melt zones. One zone had a marked increase in yellowness compared to the other. When a different style rotor was substituted for the long style rotor, a decrease in energy consumption per kWh/kg and whiter melt color were directly observed.

While the invention has been described with respect to a limited number of embodiments, the specific features of one embodiment should not be attributed to other embodiments of the invention. No single embodiment is representative of all aspects of the inventions. Moreover, variations and modifications therefrom exist. For example, the multimodal polyolefin feed components may comprise a third component, either ethylene homopolymer or copolymer, which makes the composition tri-modal in the overall molecular weight distribution. Similarly, a fourth, fifth, or sixth component may also be added to adjust the physical properties of the composition.

Various additives may also be used to further enhance one or more properties. In other embodiments, the feed components consist essentially of the LMW component and the HMW component described herein. In some embodiments, the feed composition is substantially free of any additive not specifically enumerated herein. In certain embodiments, the feed composition is substantially free of a nucleating agent. Cross-linking by physical or chemical methods may be another way to modify the feed composition. The appended claims intend to cover all such variations and modifications as falling within the scope of the invention.

What is claimed:

1. A process for producing a homogeneous polyolefin composition comprising the steps of:
a. providing one or more high molecular weight olefin polymer components and one or more low molecular weight polyolefin components;
b. compounding the high molecular weight olefin polymer component and the low molecular weight polyolefin component in a mixer comprised of two or more dissimilar rotors offset to one another at the apex to create a homogeneous multimodal polyolefin melt;
c. moving the melt from the mixer into an extruder; and
d. pressurizing the melt to move it from the extruder through a pelletizing die plate, wherein the polymer flow is divided into separate streams and cut into homogeneous multimodal polyolefin composition pellets.

2. The process of claim 1, wherein the low molecular weight olefin polymer component is polymerized in one reactor, the high molecular weight olefin polymer component is polymerized in a different reactor, and wherein the two reactors are operated in series or operated in parallel.

3. The process of claim 1 wherein the high molecular weight olefin polymer component is selected from the group consisting of ethylene, propylene, butene-1, pentene-1,4-methyl-pentene-1, hexene-1, octene-1 and decene-1.

4. The process of claim 1 wherein the low molecular weight olefin polymer component is selected from the group consisting of ethylene, propylene, butene-1, pentene-1,4-methyl-pentene-1, hexene-1, octene-1 and decene-1.

5. The process of claim 1 wherein the low molecular weight olefin component and the high molecular weight olefin component are each ethylene polymers polymerized using a slurry polymerization process.

6. The process of claim 5, wherein each slurry polymerization process takes place in a slurry loop or slurry autoclave.

7. The process of claim 5, wherein the polymerization processes are operated sequentially.

8. The process of claim 1 wherein the low molecular weight olefin component and the high molecular weight olefin component are each ethylene polymers polymerized using a gas phase polymerization process.

9. The process of claim 8, wherein the polymerization processes are operated sequentially.

10. The process of claim 1, wherein the homogeneous multimodal polyolefin pellet product comprises a bimodal polyethylene blend made from a higher molecular weight ethylene copolymer and a lower molecular weight ethylene polymer and having a melt index (MI5) 190/5 of from 0.15 to 0.45 g/10 min, a density of from 0.947 to 0.955 g/cc, and an environmental stress cracking resistance ESCR (PENT) of greater than 500 hour.

11. The process of claim 1, wherein the rotors are operated at different speeds.

12. The process of claim 11, wherein the rotor speeds are from about 228 rpm to about 258 rpm.

13. The process of claim 1, wherein the gel area of a film generated from the polyolefin composition is less than 265 per 236 square inches.

14. The process of claim 1, wherein the b-color of the polyolefin composition of the invention is less than 5.0.

15. The process of claim 1, wherein the specific energy on the polyolefin composition is less than 0.2 kWh/kg in the mixer.
